(19) United States
(12) Patent Application Publication
(10) Pub. No.: US 2012/0158546 A1
(43) Pub. Date: Jun. 21, 2012

(54) SYSTEM AND METHOD FOR IDENTIFYING DIGITAL ARTICLES OF COMMERCE WITH A PORTABLE MOBILE DEVICE AND LINKING THE ARTICLE TO A SOCIAL NETWORKING SITE

(75) Inventor: Leigh M. Rothschild, Sunny Isles Beach, FL (US)

(73) Assignee: REAGAN INVENTIONS, LLC, Sunny Isles Beach, FL (US)

(21) Appl. No.: 13/331,165

(22) Filed: Dec. 20, 2011

Related U.S. Application Data
(60) Provisional application No. 61/425,292, filed on Dec. 21, 2010.

(51) Int. Cl. G06Q 30/00; G06F 17/21; G06F 17/00

(52) U.S. Cl. 705/26.62; 235/375; 715/234

(57) ABSTRACT

Systems and methods are provided for identifying an article of commerce, e.g., a DVD, book, or grocery item and linking that item to a social networking site by placing a description of the item on the social networking site or automatically setting up a page on a social networking site so that other users can discuss, purchase, rate, and share information on the article of commerce selected.

This application claims priority on U.S. Provisional Application No. 61/425,292 filed on Dec. 21, 2010, the contents of which are hereby incorporated by reference.

### BACKGROUND

1. Field

The present disclosure relates generally to digital media content systems, and more particularly, to devices, systems and methods for identifying an article of commerce, e.g., a DVD, book, or grocery item and linking that item to a social networking site by placing a description of the item on the social networking site or automatically setting up a page on a social networking site so that other users can discuss, purchase, rate, and share information on the article of commerce selected.

2. Description of the Related Art

Portable digital devices are now common. Mobile phones were primarily used to perform standard communications services such as telephone calls and text messages. Currently, the majority of mobile phones are now equipped to play music and other media, take photographs and videos, and connect to the internet. Similarly, portable tablets such as the iPad are increasingly common and can perform a wide variety of functions. For instance, with either a mobile phone or a tablet device, an individual can find driving directions, train schedules, or movie times. Additionally, portable digital devices can be used to transmit data to the internet. Frequently, an individual will take a photograph with the portable digital device and transmit the image to another person or to the internet.

One increasingly popular use of portable digital devices is to identify articles of commerce and receive information about the article from the internet. For instance, an iPhone can be used to scan a barcode on an item and display price and other specifications relating to the item. While occasionally useful, the barcode is usually displayed on a price tag and is sometimes removed from the article immediately after purchase. Therefore, this application may be limited to in-store use, where signage and sales people are usually able to provide price and specification information.

Visual Search Technology has been developed to identify objects on the basis of physical characteristics. Typically, an internet search, such as a Google search, relies on keywords. Thus, a search for a particular article of commerce begins with a textual description of the article. Digitized images consist of arrays of pixel intensities with no inherent meaning, and the image databases that contain them are generally unstructured. Content-Based Information Retrieval (CBIR) is the process of searching for and retrieving images from an unstructured database based on information extracted from the content of those images. When searching a database for visual images, CBIR systems base their retrievals on the content of an image, and not on external tags, such as file name, captions, headings, keywords attached as meta tags, etc. This focus on content, rather than manually defined external tags, provides CBIR systems with the potential to be qualitatively more effective for image searches than any other type of search.

A textual search can be limiting. For example, if a person wants to find a specific article of clothing for sale on the internet, the person must know the designer and visit the designer's website directly. Alternatively, the person can perform a keyword search on a search engine using a phrase like, “Ralph Lauren striped shirt.” In the instance where the person sees another individual wearing the shirt in public and wants to purchase the shirt for himself, the keyword search is not really an option. However, with Visual Search Technology, the person can merely take a picture of the shirt, upload the picture to a search engine, and perform an image search for the article.

In the previous example, the person is able to use Visual Search Technology to identify the item, but does not receive any information relating to the quality of the article. The person may then search internet sites to read customer reviews. However, these reviews are typically anonymous and are not always trustworthy. Thus, there is a need for a system and method that allows a person to upload a digital image of an article of commerce to an internet site, specifically a social networking site, and solicit product information and product comments from trustworthy sources.

### SUMMARY

A system and method are provided for identifying an article of commerce with a portable digital device and linking the article to a social networking site. A portable mobile device with a camera is provided. The system and method take an image or photograph captured by a user and use Visual Search Technology to identify an article of commerce in the image. Further, the system and method are configured to communicate with a remote server and post identifying information relating to the article of commerce on a social networking site.

In one aspect of the present invention, a method for identifying an article of commerce with a portable mobile device and posting information relating to the article to a social networking site is provided. The method includes pre-registering for a social networking site. The user may store a user name and password for the social network, format a page that will display articles of commerce uploaded by the user, and preselect the type of information that will be displayed with the article.

The method further includes the step of capturing an image of the article of commerce. A camera included in the mobile device may be used to take a photograph of the article. Alternatively, a UPC scanner may be used to scan the barcode of the article.

The method further includes the step of using the local processor of the mobile device to identify the article. The local processor is equipped with visual search technology software and searches the internet for information relating to the article. If the local processor is unable to identify the article, the local processor will transmit the image to the remote server. If the remote server is unable to identify the article, an error message will be generated on the mobile device to tell the user that identifying information could not be found. If either the local processor or remote server is able to identify the article, identifying information is displayed on the mobile device. The identifying information may include, but is not limited to, brand and manufacturer information, price information, and e-commerce information instructing the user as to where the article can be purchased.

The method further includes the step of prompting the user to enter information about the article. The user may upload comments or questions relating to the article. Ideally, the user can solicit information relating to the product, including but not limited to reviews, from others within the social network.

The method further includes the step of transmitting the identifying information, image and user comments to a social networking site for display. The social networking site will display the article and related information in accordance with the format selected by the user. Additionally, the social networking site generates and displays any other information selected during the pre-registration process by the user.

The invention also relates to a system for identifying articles of commerce and linking the article to a social networking site. A mobile device is provided with a local processor, a communications module, and a camera imaging system. The communications module may use any communications technology now known or known in the future, such as satellite, wi-fi, 3G, or cellular technology. The communications module connects the local processor with a remote server.

The camera imaging system may include, but is not limited to Charged Coupled Devices (CCD) or any other type of imaging system that is equipped for imaging the article of commerce. In an alternate embodiment, the user may capture an image of the barcode or other identifying symbology.

The remote server is equipped with Visual Search Technology software, barcode scanning software, and/or any other kind of image identification technology now known or known in the future. The remote server processes images received from the portable digital device and creates a webpage on a social network. The social network may be any existing social network, such as Facebook, Twitter, MySpace, or Google Plus, or any future social network. Remote users are then invited to share product descriptions, reviews, and price information on the article.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a schematic illustration of a system for identifying articles of commerce with a portable mobile device and linking the article to a social networking site; and

FIG. 2 is a flow chart illustrating a method for identifying articles of commerce with a portable mobile device and linking the article to a social networking site.

### DETAILED DESCRIPTION

Preferred embodiments of the present disclosure will be described hereinbelow with reference to the accompanying drawings. In the following description, well-known functions or constructions are not described in detail to avoid obscuring the present disclosure in unnecessary detail.

Embodiments of the present disclosure overcome the shortcomings of existing practices and provides a system and method for identifying an article of commerce with a portable digital device and linking the article to a social networking site.

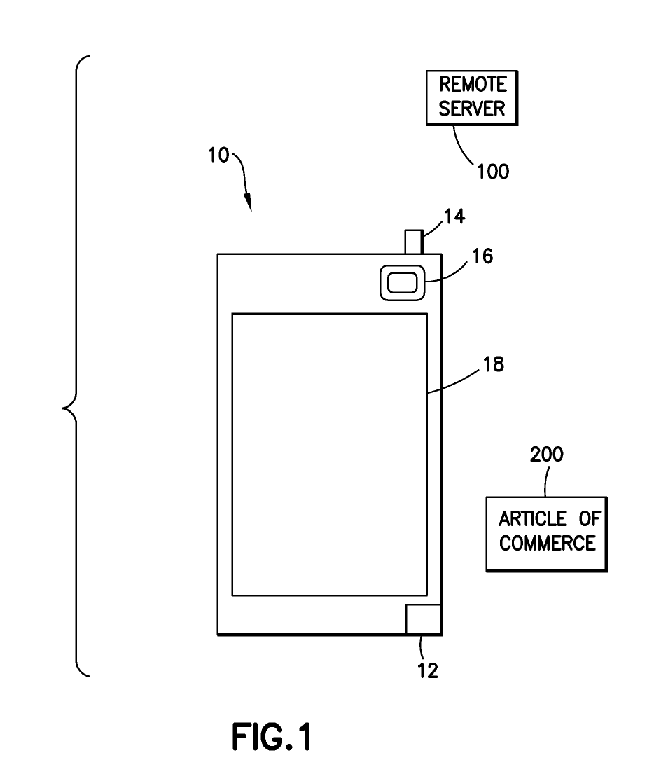

Referring to FIG. 1, a system for identifying an article of commerce and linking the article to a social networking site is provided. The system comprises a mobile device 10, such as a mobile phone, computer, or tablet. The mobile device 10 has a local processor 12, a communications module 14, an imaging system 16, and a display screen 18. In the preferred embodiment, the imaging system 16 may include, but is not limited to charged coupling devices. However, the imaging system 16 may be a UPC scanning device, equipped to identify a barcode or other symbology on an article of commerce 200. The communications module 14 may use any communications technology now known or known in the future, such as satellite, wi-fi, 3G, or cellular technology. The communications module 14 connects the local processor 12 with a remote server 100.

The local processor 12 is equipped with Visual Search Technology and can connect to the internet using the communications module 14 or other known devices. The local processor 12 uses the Visual Search Technology to search the internet for an image captured by the imaging system 16.

The remote server 100 is equipped with Visual Search Technology software, barcode scanning software, and/or any other kind of image identification technology now known or known in the future. The remote server 100 processes images received from the mobile device 10 and creates a webpage on a social networking site. The social networking site may be any existing social network, such as Facebook, Twitter, MySpace, or Google Plus, or any future social network. Remote users are then invited to share product descriptions, reviews, and price information on the article of commerce 200.

It is to be understood that the present disclosure may be implemented in various forms of hardware, software, firmware, special purpose processors, or a combination thereof. In one embodiment, the present disclosure may be implemented in software as an application program tangibly embodied on a program storage device. The application program may be uploaded to, and executed by, a machine comprising any suitable architecture such as server 100. The machine is implemented on a computer platform having hardware such as one or more central processing units (CPU), a random access memory (RAM), a read only memory (ROM) and input/output (I/O) interface(s) such as a keyboard, cursor control device (e.g., a mouse or joystick) and display device. A system bus couples the various components and may be any of several types of bus structures including a memory bus or memory controller, a peripheral bus, and a local bus using any of a variety of bus architectures. The computer platform also includes an operating system and micro instruction code. The various processes and functions described herein may either be part of the micro instruction code or part of the application program (or a combination thereof) which is executed via the operating system. For example, in the case of the remote server 100, the micro instruction code or application software may be executing to generate web pages of the social networking site.

An exemplary system including a mobile device and server for identifying articles of commerce is described in pending U.S. application Ser. No. 11/479,366, the contents of which are hereby incorporated by reference.

It is to be further understood that because some of the constituent device components and method steps depicted in the accompanying figures may be implemented in software, the actual connections between the device components (or the process steps) may differ depending upon the manner in which the present disclosure is programmed. Given the teachings of the present disclosure provided herein, one of ordinary skill in the related art will be able to contemplate these and similar implementations or configurations of the present disclosure.

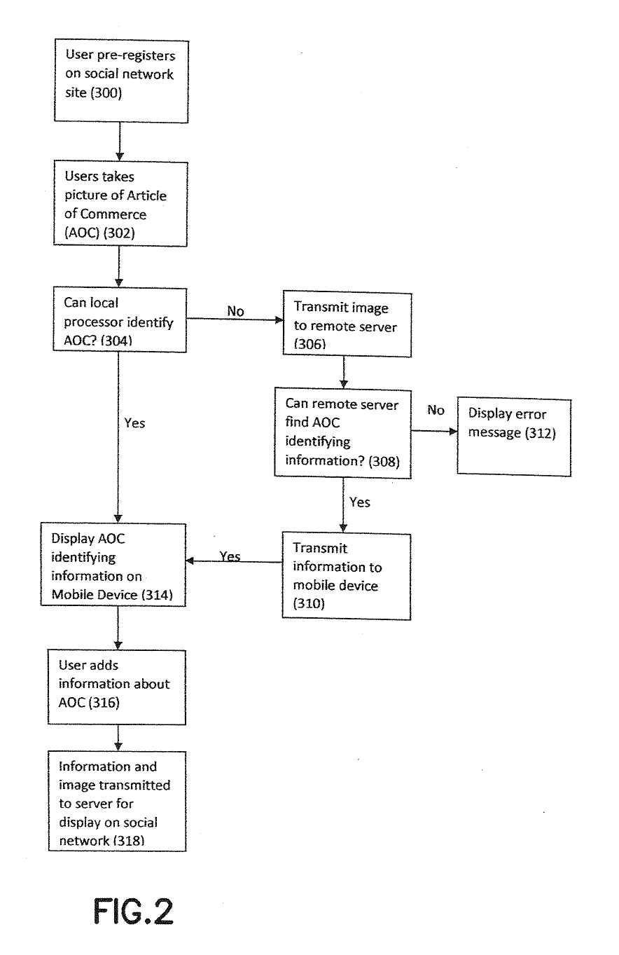

With reference to FIG. 2, a method of the present invention will now be disclosed. A user pre registers for a social networking site (step 300). The user may store a user name and password for the social network, format a page that will display articles of commerce uploaded by the user, and preselect the type of information that will be displayed with the article. The user captures an image of the article of commerce 200 using the imaging system 16 (step 302). The local processor 12 analyzes the image and searches the internet for identifying information relating to the article of commerce 200 using visual search technology (step 304). If the local processor 12 is unable to locate identifying information, the image is transmitted to the remote server 100 (step 306). In the preferred embodiment, the remote server 100 has higher processing speeds than the local processor 12. The remote server 100 performs a search using visual search technology for information on the article of commerce 200 (step 308). If the remote server 100 locates identifying information relating to the article of commerce 200, the remote server 100 transmits the identifying information to the local processor 12 (step 310). If the remote server 100 is unable to locate identifying information, an error message is transmitted to the local processor 12 for display on the display screen 218 (step 312).

The method further includes the step of displaying the identifying information for the article of commerce 200 on the display screen 18 of the mobile device 10 (step 314). The user is given an option to add more information about the article of commerce 200 (step 316). The information added by the user may comprise questions for other users, comments, reviews, and information relating to the location of the article of commerce 200. The image of the article of commerce 200 and the identifying information are transmitted to the remote server 100 for display on the social networking site (step 318).

Applications of the Invention Will Now be Described in Detail.

A user goes to a video store and locates a video that they are interested in renting. The user utilizes their portable mobile device to scan in an image of the selected DVD. The selected DVD is then recognized by the user's mobile device and the user indicates pertinent information that they would like to note on the selected DVD, The article of commerce is then posted onto the selected social networking website by the user and the user is notified on his mobile device of the posting.

A user goes to an electronics store and purchases a LCD television monitor. After purchase, the user scans the barcode on the packaging of the monitor. The mobile device user software to resolve the identity of the monitor and then allows the user to input a review of the LCD monitor. Upon completion of the review the user indicates which selected social networking website they would like to post the review on. The mobile device then communicates with the selected social networking website and formats and posts the review. The user is then provided a link to the selected social networking website site so that he can read or edit the posted review.

A user goes to a drugstore and selects a pharmaceutical item. The user then uses their mobile device to scan in the symbology associated with the item or alternatively to capture an image of the item and use the visual search technology software in the mobile device to identify the item. Once the mobile device identifies the selected item the user may then use a selected social networking website such as Twitter to notify selected users (either selected by the user post identification of the item or preselected by the user) that the user is interested in the selected pharmaceutical item. The device may also automatically transmit additional information to the selected users including the date and time of the selection, and the location and name of the retailer of the selected item. The user may then conduct a dialogue on the selected item utilizing the communication path that the social networking site provides (in this case by example Twitter).

While the disclosure has been shown and described with reference to certain preferred embodiments thereof, it will be understood by those skilled in the art that various changes in form and detail may be made therein without departing from the spirit and scope of the disclosure as defined by the appended claims.

What is claimed is:

1. A method for identifying an article of commerce with a portable mobile device and linking the article to a social networking website, the method comprising:
registering on a social networking website;
capturing an image of an article of commerce using a mobile device;
searching for information relating to the article of commerce;
displaying information about the article of commerce on the mobile device; and
uploading information about the article of commerce to the social networking website.

2. The method of claim 1, wherein the information about the article of commerce comprises customer reviews and ecommerce websites.

3. The method of claim 1, wherein the local processor in the mobile device uses visual search technology to search for information relating to the article of commerce on the internet.

4. The method of claim 1, further comprising the steps of transmitting the image to a remote server and using the remote server to search for article of commerce information on the internet.

5. The method of claim 3, wherein an error message is displayed on the mobile device if information on the article of commerce is not found by the remote server.

6. The method of claim 1, further comprising the step of prompting the user to enter information relating to the article of commerce.

7. The method of claim 1, further comprising the step of creating a webpage on the social networking website for displaying the article of commerce.

8. The method of claim 7, wherein the webpage is displayed on a pre-selected webpage template.

9. The method of claim 7, wherein an internet address for the webpage is transmitted to the user.

10. The method of claim 1, wherein the step of capturing an image of the article of commerce comprises capturing an image of a barcode on the article of commerce and scanning the barcode for identifying information.

11. The method of claim 10, further comprising the step of searching the internet for barcode information.

12. The method of claim 1, further comprising the step of notifying users of the article of commerce and soliciting comments from the users on the social networking site.

13. A system for identifying articles of commerce and linking the article of commerce to a social networking site, comprising:
a mobile device including
an imaging system that captures an image;
a local processor that identifies the article of commerce;
a display screen;
a communications module that transmits an image or identifier of the AOC captured by the image to a remote server; wherein
the remote server links the article of commerce to the social networking site.

14. The system of claim 13, wherein the local processor and communications module are disposed in the mobile device.

15. The system of claim 13, wherein the imagining system is a digital camera.

16. The system of claim 13, wherein the imagining system is a UPC scanner for scanning a barcode.

17. The system of claim 13, wherein the remote server notifies users that the article of commerce is linked to the social networking site and solicits comments about the article of commerce from said users.

18. A social networking system, comprising:
a website;
an article of commerce;
a mobile device having an imaging system for capturing an image of the article of commerce, a local processor having visual search technology software, and a communications module; and
a remote server having visual search technology software and in communication with the local processor through the communications module;
wherein at least one of the local processor and the remote server perform an internet search for identifying information relating to the image article of commerce and display the information on the website.

19. The system of claim 18, further comprising a UPC scanner for scanning a barcode disposed on the article of commerce.

20. The system of claim 19, wherein at least one of the local processor and remote server has UPC scanning software for reading the barcode.
